(19) United States
(12) Patent Application Publication
(10) Pub. No.: US 2025/0246945 A1
(43) Pub. Date: Jul. 31, 2025

(54) SYSTEM FOR INDUCTIVE ENERGY TRANSFER

(71) Applicant: MAHLE International GmbH, Stuttgart (DE)

(72) Inventor: Mike Boettigheimer, Kornwestheim (DE)

(21) Appl. No.: 18/854,514

(22) PCT Filed: Apr. 6, 2023
(86) PCT No.: PCT/EP2023/059098

§ 371 Date: Oct. 4, 2024

(30) Foreign Application Priority Data
Apr. 7, 2022 (DE) 10 2022 203 489.9

(51) Int. Cl. H02J 50/90; H01F 38/14; H02J 50/00; H02J 50/10

(52) U.S. Cl. CPC H02J 50/90; H01F 38/14; H02J 50/005; H02J 50/10

(57) ABSTRACT

A system for inductive energy transfer may include a stationary induction charging device including a stationary energy coil, a mobile induction charging device including a mobile energy coil, and a positioning device configured to detect a positioning of the stationary energy coil and the mobile energy coil relative to one another. During a charging operation of the system, one of energy coils may provide an alternating magnetic field which induces a voltage for energy transfer in the other energy coil and/or the induction charging devices may be disposed spaced apart from one another in a height direction. The positioning device may include i) four transmission coils in one of the induction charging devices and ii) at least one receiver in the other induction charging device. The transmission coils may, during a positioning operation, provide positioning fields that are distinguishable from one another.

### CROSS-REFERENCE TO RELATED APPLICATIONS

This application claims priority to International Patent Application No. PCT/EP2023/059098, filed on Apr. 6, 2023, and German Patent Application No. DE 10 2022 203 489.9, filed on Apr. 7, 2022, the contents of both of which are hereby incorporated by reference in their entirety.

### TECHNICAL FIELD

The present invention relates to a system for inductive energy transfer having a stationary induction charging device and a mobile induction charging device, which interact with one another in a charging operation for inductive energy transfer. The invention also relates to such an induction charging device and a mobile application with such an induction charging device.

### BACKGROUND

A system for inductive energy transfer usually comprises a stationary induction charging device and a mobile induction charging device. In a charging operation, an energy coil of one of the induction charging devices acts as a primary coil and the energy coil of the other induction charging device acts as a secondary coil. Such systems are typically used for inductive energy transfer to a mobile application, for example to a motor vehicle, wherein the mobile application comprises the mobile induction charging device. In mobile applications, the energy coil of the mobile induction charging device is usually the secondary coil during charging operation. For inductive energy transfer, the primary coil generates an alternating magnetic field, which induces a voltage in the secondary coil. In order to make inductive energy transfer possible and to increase the efficiency of inductive energy transfer, the primary coil and the secondary coil and thus the energy coils of the induction charging devices must be positioned correspondingly relative to one another. For this purpose, it is conceivable to equip the system with a corresponding positioning device.

A corresponding system is known, for example, from EP 2 727 759 B1. The system comprises a positioning device for a motor vehicle having the mobile induction charging device in order to be able to navigate the motor vehicle. The induction charging device has a transmitter and a receiver.

DE 10 2012 205 283 A1 shows a system with a positioning device which has an even number of detector coil elements which are wound oppositely in pairs and form a detector pair.

The system shown in EP 3 347 230 B1 comprises a positioning device which in the mobile induction charging device has a transmitter unit which during operation emits a transmission signal of a predetermined frequency. In the stationary induction charging device the positioning device further comprises a receiver unit which receives the transmission signal and identifies a signal part of the transmission signal. On the basis of the identified signal part, a relative position is determined.

DE 10 2017 215 932 B3 describes a method for determining position information of a motor vehicle on a surface. The motor vehicle has a mobile induction charging device. By energizing the energy coil of the mobile induction charging device, at least one magnetic structure arranged in or on a surface over which the motor vehicle travels is magnetized. The structure is stored in a digital map together with a position indication of the relevant structure, whereby the position of the motor vehicle is identified on the basis of the magnetized structure.

### SUMMARY

The present invention relates to the object of providing improved or at least different embodiments for a system of the type mentioned at the outset, for an induction charging device of the system and also for a mobile application with a mobile induction charging device of the system, which embodiments in particular eliminate disadvantages of the prior art. In particular, the present invention relates to the object of providing improved or at least different embodiments for the system, for the induction charging device and for the mobile application, which embodiments are characterized by increased precision and/or increased robustness of the detection of the relative positioning of the energy coils of the system.

This object is achieved according to the invention by the subject matter of the independent claim(s). Advantageous embodiments are the subject-matter of the dependent claim(s).

The present invention is therefore based on the general idea of arranging four transmission coils in a system with two energy coils that interact inductively in a charging operation relative to one of the energy coils, which four transmission coils generate fields that can be distinguished from one another, and of arranging at least one receiver of the fields relative to the other energy coil, wherein the ratio between at least two of the fields generated by the transmission coils is ascertained by means of the at least one receiver in order to detect the position of the energy coils relative to one another. Due to the fixed arrangement of the transmission coils in relation to the associated energy coil and the fixed arrangement of the at least one receiver in relation to the other energy coil, the ratio changes depending on the position of the energy coils relative to one another. The energy coils are thus arranged to overlap one another in a predetermined ratio of the fields. In this way, the relative position of the energy coils and in particular an overlapping arrangement of the energy coils in relation to one another can be ascertained in a simple and effective manner. Since field ratios are used to detect the relative position of the energy coils in relation to one another, a reliable ascertainment of the relative position is provided, in particular in comparison to ascertainments of absolute values known from the prior art. This is in particular due to the fact that the ratio of the received fields does not change or only changes slightly as the distance changes in the height direction. In this way, for example, mobile induction charging devices in associated applications can be installed or arranged at different heights and/or stationary induction charging devices can be installed or arranged at different heights or depths and the position of the energy coils relative to one another can still be detected without further calibration. The concept according to the invention therefore simplifies the detection of the position of the energy coils relative to one another.

As explained, using the ratio to detect the position of the energy coils relative to one another has in particular the advantage that repeated calibration of induction charging devices that inductively transfer energy to one another can be dispensed with. This means that at least one ratio can be predetermined in advance, whereby when determining such a ratio from the received fields it is recognized that there is a corresponding position of the energy coils relative to one another. In this way, it is possible in particular to transfer said predetermined ratios from the induction charging device generating the fields once, preferably before the positioning starts, to the receiving induction charging device in order to determine the position of the energy coils relative to one another. Alternatively and preferably, the ratios are fixed so that the predetermined ratio is stored in the receiving induction charging device and thus no transmission to the receiving induction charging device is necessary. In particular, this allows the relative position between energy coils of different stationary induction charging devices and different mobile induction charging devices to be determined in a simple and robust manner without prior calibration.

According to the inventive concept, the system has a stationary induction charging device with an energy coil and a mobile induction charging device with a mobile energy coil. In the charging operation of the system, one of the energy coils generates an alternating magnetic field which for energy transfer induces a voltage in the other energy coil. During charging operation the induction charging devices, in particular the energy coils, are spaced apart from one another in a height direction. The system further comprises a positioning device for detecting the position of the energy coils relative to one another. The positioning device has four transmission coils in one of the induction charging devices and a receiver in the other induction charging device. The transmission coils are spaced apart from one another, wherein two of the transmission coils are arranged lying opposite one another in such a way that the transmission coils delimit a virtual frame. The frame defines a virtual frame volume that extends from the frame in the height direction. The energy coil of the associated induction charging device is at least partially arranged within the virtual frame volume. The positioning device is designed such that the transmission coils generate fields that can be distinguished from one another in a positioning operation and which are also referred to hereinafter as positioning fields. In addition, the at least one receiver is designed such that during positioning operation it interacts with the positioning fields generated by the transmission coils. Furthermore, the positioning device is designed such that during the positioning operation it ascertains the ratio between at least two of the positioning fields by means of the at least one receiver and, on the basis of the at least one ratio, recognizes whether the energy coil of the induction charging device having the receiver is located within the virtual frame volume and depending thereon outputs a positioning signal.

The identified ratio corresponds appropriately to the local ratio of the positioning fields.

The positioning can comprise bringing the energy coils closer to one another as well as precisely positioning the energy coils relative to one another, hereinafter also referred to as near-field positioning. The positioning device described here is appropriately used for near-field positioning. Near-field positioning is advantageously used when the energy coils are spaced apart by less than 1.0 m, preferably by less than 0.5 m, in order to position them precisely relative to one another. At least one proximity field can be used to bring the energy coils closer together.

The relevant energy coil preferably has at least one winding. In the scope of the present invention, the extension of the energy coil is to be understood as meaning in particular the entire surface area spanned by the at least one winding. In the case of a flat coil, even the central region, in which no winding can be present, thus belongs to the energy coil.

During operation, the particular transmission coil generates a positioning field of a magnetic and/or electromagnetic nature. This means that the relevant positioning field is a magnetic and/or electromagnetic field.

It is conceivable, for example, to generate at least one of the positioning fields as an electromagnetic positioning field in the ultra-broadband range.

In preferred embodiments, at least one of the at least one transmission coils, preferably the particular transmission coil, generates a magnetic positioning field during the positioning operation. A magnetic positioning field has the advantage over an electromagnetic positioning field that the receiver receives the positioning field more easily and reliably. In addition, it is in this way possible to dispense with calibration, which is necessary, for example, in the case of time-of-flight differences, as are usually required for electromagnetic and/or acoustic fields. The magnetic positioning field thus allows for a simplified and robust determination of the ratios and thus of the position of the energy coils relative to one another. In particular, the elimination of the calibration carried out during the relevant positioning further means that the positioning can be carried out between different induction charging devices. In other words, the use of magnetic positioning fields allows positioning to be easily implemented with different induction charging devices.

Preferably, a main axis of the relevant positioning field runs along the height direction. The particular positioning field therefore propagates at least predominantly in or along the height direction and can thus be received transversely to the height direction only locally in the region of the associated transmission coil and energy coil, i.e., substantially on or in the immediate vicinity of the energy coil. The positioning fields are thus used to determine the relative position locally and thus close to the stationary induction charging device, i.e., when the mobile induction charging device has already approached the stationary induction charging device. Such main axes have the advantage that the determination of the relative position is more precise, in particular because the relevant volume is defined more precisely. On the other hand, overlaps between positioning fields of induction charging devices that neighbor transversely to the height direction, for example of neighboring stationary induction charging devices, are prevented or at least reduced in this way. The latter results in turn to a more precise determination of the relative position as well as to a simplified, interference-reduced and reliable operation of several neighboring induction charging devices, for example of neighboring stationary induction charging devices.

The main axis of a positioning field running along the height direction is advantageously achieved by winding the associated transmission coil around a winding axis running parallel or substantially parallel to the height direction. The transmission coil thus has at least one conductor track through which current flows during operation and which is wound around the winding axis running parallel or substantially parallel to the height direction.

If the energy coil of the induction charging device having at least one receiver is located within the frame volume, this means that the energy coils will be arranged one above the other in the height direction and overlap one another transversely to the height direction.

The ratio which represents an arrangement, within the frame volume, of the energy coil of the induction charging device having the at least one receiver is appropriately predetermined in advance. Preferably, the predetermined ratio is stored so that by comparing the ratio identified by means of the at least one receiver, hereinafter also referred to as the identified ratio, with the stored ratio, it is recognized whether the energy coil of the induction charging device having the at least one receiver is located within the frame volume.

As explained above, the frame is bounded by the transmission coils. The frame is a surface area, whereby the surface area defines the frame volume. The frame volume extends from the surface area in the height direction. Accordingly, the energy coil of the induction charging device having the transmission coils is arranged either in the frame or offset in the height direction from the frame.

During the charging operation, one of the energy coils acts as a primary coil generating the alternating field and the other energy coil acts as a secondary coil in which the alternating field induces the voltage.

Typically, the energy coil of the stationary induction charging device serves as the primary coil, and the energy coil of the mobile induction charging device serves as the secondary coil. Variants are also conceivable in which the mobile induction charging device inductively transfers energy to the stationary induction charging device. A bidirectional transfer of energy is also conceivable.

The system is used in particular to inductively transfer energy to a mobile application which comprises the mobile induction charging device. The voltage induced in the energy coil of the mobile induction charging device during charging operation can be used to charge a battery. For this purpose, a rectifier can be provided between the energy coil and the battery.

In particular, the system is used to inductively transfer energy to a motor vehicle as a mobile application, for example to charge a battery of the motor vehicle.

In particular in the case of a mobile application, the positioning signal can be used to specify a relative movement of the mobile induction charging device in relation to the stationary induction charging device such that the energy coils are both arranged in the frame volume. The positioning signal can therefore be used for the navigation of the mobile induction charging device or associated application. For this purpose, for example, a person, in particular a motor vehicle driver, can be given instructions to move, in particular to drive, the application depending on the positioning signal. For example, visual and/or acoustic signals can be output for this purpose. Alternatively or additionally, it is conceivable to carry out an autonomous movement of the application, in particular of the motor vehicle, depending on the positioning signal, in order to achieve the arrangement of both energy coils within the frame volume.

In advantageous embodiments, the positioning device is designed such that a virtual target region is bounded within the frame. The target region defines a virtual target volume within the frame volume, which extends from the target region in the height direction and in which the energy coil of the induction charging device having the transmission coils is at least partially arranged. Furthermore, the positioning device is designed such that it detects, on the basis of the at least one ratio, whether the energy coil of the induction charging device having the at least one receiver is located within the target volume. The target volume is therefore a partial volume of the frame volume. In this way, the detection of the relative position of the energy coils is improved and more precise. In addition, when both energy coils are arranged in the target volume, a larger overlap of the energy coils and thus a higher efficiency in charging operation is achieved than when both energy coils are arranged within the frame volume and outside the target volume.

Advantageously, the frame volume and target volume are selected in such a way, i.e., the transmission coils are arranged in such a way and/or the positioning fields are generated in such a way, that when the energy coils within the frame volume and/or within the target volume overlap during charging operation, an efficiency of at least 90% is achieved.

In principle, the system can comprise two or more receivers.

In preferred embodiments, the system comprises a single receiver. The system is thus simplified and cost-effective.

In principle, the at least one receiver can be designed in any way.

In particular, at least one of the at least one receivers is a coil, which is also referred to hereinafter as a receiver coil.

During operation, the positioning fields induce a voltage in the at least one receiver coil, which is output as an output signal of the receiver coil, in order to determine the ratio of at least two of the positioning fields.

In particular, at least one of the at least one receiver coils can be designed as a flat coil.

In principle, at least one of the at least one receiver coils can correspond to the energy coil of the induction charging device having the receiver coil.

It is also conceivable that the energy coil of the induction charging device having the at least one receiver is different from the energy coil of the associated induction charging device.

The relevant positioning field advantageously has a location-dependent intensity curve with an intensity flank leading to the intensity maximum.

It is understood that the at least one receiver has a lower threshold for interaction with the positioning fields. This in particular results in the at least one receiver interacting with the positioning fields below a predetermined distance from them. In principle, the positioning device, in particular the transmission coils, can be in permanent operation. It is conceivable to initiate the positioning operation when the corresponding distance between the at least one receiver and the positioning fields, in particular between the induction charging devices, is undershot. This can be done in particular by the mobile induction charging device sending out a ping signal, which, when received by the stationary induction charging device, causes the transmission coils to generate the positioning fields.

Embodiments are considered advantageous in which during the positioning operation the particular transmission coil generates a positioning field with an intensity maximum, wherein the transmission coils are arranged spaced apart from one another and/or the positioning device is operated in such a way that the intensity maxima of the positioning fields are spaced apart from one another and the positioning fields of at least two of the opposite-lying transmission coils coincide in the frame volume, in particular in the target volume, i.e., are in particular in each case present in a measurable manner. The coincidence of the positioning fields permits a simplified and reliable determination of the associated ratio and thus a simplified and robust detection of the position of the energy coils relative to one another.

In preferred embodiments, the positioning device is designed such that the frame volume, advantageously the target volume, is arranged in a predetermined ratio range between the intensity maxima of the positioning fields of the relevant opposite-lying transmission coils. The ratio range is thus assigned to the opposite-lying transmission coils, so that if a ratio is identified within the associated ratio range, an overlap of the energy coils along the opposite-lying transmission coils can be detected. In this way, it is not only possible to detect an overlap of the energy coils with one another but also a direction in which the energy coils overlap transversely to the height direction. Amore precise detection of the position of the energy coils relative to one another is thereby achieved. Furthermore, it is possible in this way to output positioning signals which result in a navigation of the mobile induction charging device or of the associated application in such a way that the energy coils overlap one another.

At least one ratio range, analogously to the ratio, is predetermined in advance. In this case, the at least one ratio range is preferably stored so that, with the aid of a comparison of the identified ratio in relation to the associated ratio range, it can be recognized whether there is an overlap of the energy coils along the associated opposite-lying transmission coils and/or whether there is an offset along the associated opposite-lying transmission coils.

Here the frame volume and the target volume can each be assigned associated ratio ranges. Appropriately, the at least one ratio range assigned to the target volume is narrower than the at least one ratio range assigned to the frame volume.

For example, at least one of the at least one ratio ranges assigned to the target volume may be between 1:0.1 and 0.1:1.

For example, at least one of the at least one ratio ranges assigned to the frame volume may be between 10:0.05 and 0.05:10.

The concept according to the invention further offers the advantage that, due to the detection of the position of the energy coils relative to one another on the basis of the at least one ratio, even in the case of stationary induction charging devices and mobile induction charging devices that are spaced apart from one another at different heights, a simplified detection of the position of the energy coils relative to one another is made possible by the fact that ratios and/or ratio ranges adapted to the different distances in the height direction can be predetermined in advance and taken into account.

In preferred embodiments, at least one of the predetermined ratios, preferably the relevant ratio, is spaced apart from the intensity maxima of the associated positioning fields. Particularly preferably, at least one of the predetermined ratio ranges, preferably the relevant ratio range, is spaced apart from the intensity maxima of the associated positioning fields. Since the intensity maximum of the relevant positioning field has a local course in the form of a double hump, the use of identified ratios between the two humps is avoided. As a result, distortions in the detection of the position of the energy coils relative to one another are prevented or at least reduced.

Embodiments are advantageous in which the frame volume, in particular the target volume, is arranged between successive intensity flanks of the positioning fields generated by means of the opposite-lying transmission coils. The frame volume or target volume are thus spaced apart from the intensity maxima. As a result, the disadvantage described above, which arises due to the double-hump shape of the intensity maxima, is prevented within the entire frame volume or target volume.

In advantageous embodiments, the transmission coils are arranged spaced apart from one another and/or the positioning device is operated in such a way that the intensities of at least two of the positioning fields generated by means of the opposite-lying transmission coils correspond to one another centrally in relation to the energy coil of the induction charging device having the transmission coils. In other words, the ratio of at least two of the positioning fields generated by the opposite-lying transmission coils centrally in relation to the associated energy coil is 1:1. This makes it possible to easily and robustly detect an arrangement of the energy coils mutually centered in the direction of the opposite-lying transmission coils.

In principle, the transmission coils can be designed in any way. It is in particular conceivable that at least two of the transmission coils are designed differently.

It is conceivable that one of the transmission coils corresponds to the energy coil of the induction charging device having the transmission coils.

In preferred embodiments, the transmission coils are different from the energy coil of the induction charging device having the transmission coils.

In preferred embodiments, the transmission coils are of identical design. This makes production of the system simpler. At the same time, it is easy to implement equal intensity curves of the positioning fields.

Embodiments are preferred in which at least one of the at least one transmission coil, advantageously the particular transmission coil, is designed as a flat coil. This allows the positioning device to be built compactly.

It is preferred if the transmission coils each generate the same intensity curves during positioning operation. This makes it easier to determine the ratios and to prespecify them. The same applies to the ratio ranges.

Advantageously, at least two of the positioning fields are generated and/or transmission coils are arranged in such a way that the positioning fields are symmetrical to one another.

Preferably, the transmission coils are designed and/or the positioning device is operated in such a way that an overall intensity curve of the positioning fields generated by the transmission coils is symmetrical. The symmetry preferably applies with respect to the opposite-lying transmission coils and/or with respect to the energy coil of the induction charging device having the transmission coils. In this way the detection of the position of the energy coils relative to one another is simplified.

In preferred embodiments, two of the transmission coils are arranged opposite one another in a longitudinal direction running transversely to the height direction. These transmission coils are also referred hereinafter to as longitudinal transmission coils. It is further preferred if two of the transmission coils are arranged opposite one another in a transverse direction running transversely to the height direction and transversely to the longitudinal direction. An overlap or an offset of the energy coils relative to one another not only in the longitudinal but also in the transverse directions can thus be detected by means of the relevant associated ratios or ratio ranges. This results in an increased precision in determining the position of the energy coils relative to one another. In addition, in this way the navigation of the mobile induction charging device, in particular of the application, to the stationary induction charging device in order to achieve an overlap of both energy coils not only in the longitudinal but also in the transverse directions can be simplified and carried out more precisely.

Embodiments are advantageous in which the transmission coils are arranged such that the frame is a quadrilateral. This provides a clear bounding of the frame and thus a clear definition of the frame volume. The same applies to the target region and to the target volume.

Preferably, the frame is a rectangle and/or the transmission coils are arranged in corners of a rectangle. With the four transmission coils, two transmission coils lying opposite one another in the longitudinal direction and two transmission coils lying opposite one another in the transverse direction are thus realized. As a result, the system is designed cost-effectively and provides increased precision and robustness in detecting the position of the energy coils relative to one another. In addition, in this way the frame volume, and preferably also the target volume, has the shape of a cuboid.

In principle, the mutually distinguishable positioning fields can be implemented in any way.

Advantageously, the positioning device is designed such that the transmission coils are operated at different frequencies during the positioning operation and the positioning fields, in particular the magnetic positioning fields, can thus be distinguished. This means that each transmission coil is operated at an associated frequency or in an associated frequency band, whereby the frequencies or frequency bands of the transmission coils differ from one another.

It is conceivable to operate the transmission coils during the positioning operation with frequencies in the MHz range.

In the positioning operation, the transmission coils are advantageously operated with frequencies in the range between 5 kHz and 150 kHz. Preferably, the transmission coils are operated in the positioning operation with frequencies between 110 kHz and 148.5 kHz, particularly preferably between 120 kHz and 145 kHz.

The frequencies associated with the transmission coils are preferably as close to one another as possible so that the total required frequency spectrum is small. The frequencies are, for example, 5 kHz or 1 kHz or 100 Hz or 1 or a few Hz apart.

The mutually distinguishable positioning fields can be achieved alternatively or additionally by different duty cycles of the transmission coils. This means that the positioning device is designed in such a way that the transmission coils are operated during the positioning operation in each case with associated duty cycles and the positioning fields can thus be distinguished. The use of duty cycles means that the transmission coils can be operated at the same frequency or frequency band. A smaller frequency spectrum is thus required to operate the system or the positioning device. This also results in particular in a reduced influence of the positioning device on the components located in the vicinity.

In preferred embodiments, the stationary induction charging device has the transmission coils, and the mobile induction charging device has the at least one receiver. Since a relative movement of the mobile induction charging device in relation to the stationary induction charging device takes place in order to align the energy coils relative to one another, the determination of at least one ratio and the detection of whether there is an overlap of the energy coils can thus take place in the mobile induction charging device. In comparison to a corresponding determination in the stationary induction charging device and a transfer to the mobile induction charging device or to the associated application, the results are thus available in the mobile induction charging device or in the application. In other words, a latency in detecting the position of the energy coils relative to one another is prevented or at least reduced. This results in particular in a smooth navigation of the mobile induction charging device or of the application having the mobile induction charging device.

Preferably, the transmission coils are in each case designed as a flat coil.

At least one of the induction charging devices, preferably the relevant induction charging device, comprises a magnetic flux guide unit for guiding magnetic fields. The magnetic flux guide unit advantageously comprises at least one magnetic flux guide element, preferably at least one ferrite element.

Preferably, the induction charging device having the transmission coils has such a magnetic flux guide unit, wherein at least one of the transmission coils, preferably the particular transmission coil, is arranged above the magnetic flux guide unit, so that the magnetic flux guide unit shields the positioning fields generated by the transmission coils on the side facing away from the other induction charging device during charging operation and strengthens them towards the other induction charging device. This results in the positioning fields being strengthened towards the other induction charging device, in particular having an increased range, and at the same time interference from other components being prevented or at least reduced.

It is preferred if the induction charging device having the transmission coils comprises a flat coil as an energy coil, which is larger than the transmission coils, and also a magnetic flux guide unit with magnetic flux guide elements, in particular with ferrite plates, for guiding the alternating field generated by the stationary energy coil during charging operation. The transmission coils overlap the energy coil and are arranged in corners of a quadrilateral, advantageously a rectangle, in a plane running parallel to the energy coil.

The transmission coils can be arranged between the energy coil and the magnetic flux guide unit or on the side of a coil carrier carrying the energy coil that faces away from the energy coil.

The system can of course also comprise two or more stationary induction charging devices and/or two or more mobile induction charging devices, each of which can inductively transfer energy during charging operation after being positioned correspondingly relative to one another. This means in particular that a stationary induction charging device can also be made available to two or more mobile induction charging devices in order to inductively transfer energy with them during charging operation. For example, a stationary induction charging device in the form of a charging point can be used to charge various applications, in particular motor vehicles, wherein the applications each have such a mobile induction charging device.

The stationary induction charging devices and/or the mobile induction charging devices are preferably each designed identically.

The concept according to the invention makes it possible to take into account positionings of the mobile induction charging device in different motor vehicles at different heights, i.e., with different distances in the height direction, in a simplified manner, in particular without recalibration, preferably with no calibration.

It is understood that the system can also have five or more transmission coils, each of which generates mutually distinguishable positioning fields during operation

The system according to the invention can be used to detect the position of the energy coils relative to one another at any distance. In particular, the system can be used to navigate and align the energy coils relative to one another in any distance ranges.

The system is advantageously used for detecting the relative position and/or for navigation in the so-called near field, i.e., at distances of less than 1.5 m, preferably less than 1.0 m, in particular less than 0.5 m.

It is understood that in addition to the system, an induction charging device of the system, i.e., the stationary induction charging device and the mobile induction charging device, in each case also belong as such to the scope of this invention.

The scope of this invention also includes a mobile application, in particular a motor vehicle, with the mobile induction charging device of the system.

Further important features and advantages of the invention are apparent from the subclaims, from the drawings and from the associated description of the figures with reference to the drawings.

It is understood that the features mentioned above and those to be explained below can be used not only in the combination specified in each case, but also in other combinations or on their own, without departing from the scope of the present invention.

Preferred embodiments of the invention are illustrated in the drawings and are explained in more detail in the following description, wherein identical reference numerals refer to identical or similar or functionally identical components.

### BRIEF DESCRIPTION OF THE DRAWINGS

In the drawings, schematically in each case:

FIG. 1 is a highly simplified representation of a system for inductive energy transfer,

FIG. 2 is a schematic representation of virtual volumes,

FIG. 3 is a simplified plan view of a stationary induction charging device of the system,

FIG. 4 is a section through the stationary induction charging device,

FIG. 5 is a diagram with positioning fields,

FIG. 6 is a simplified plan view of transmission coils and a receiver of the system,

FIG. 7 is a diagram with position fields received by the receiver,

FIG. 8 is a diagram with other position fields received by the receiver,

FIG. 9 is a flow chart explaining the detection of the relative position of a mobile induction charging device of the system in relation to the stationary induction charging device,

FIG. 10 is an exploded view of parts of the stationary induction charging device,

FIG. 11 is the illustration from FIG. 10 in another embodiment,

FIG. 12 is a detailed view from FIG. 11,

FIG. 13 is a plan view of a transmission coil of the system,

FIG. 14 is a plan view of an energy coil of the system,

FIG. 15 is the section indicated by C-C in FIG. 14,

FIG. 16 is an enlarged representation of the region designated XII in FIG. 15,

FIG. 17 is the view from FIG. 16 in another embodiment,

FIG. 18 is the view from FIG. 14 in a further embodiment,

FIG. 19 is the section indicated by A-A in FIG. 18,

FIG. 20 is the section from FIG. 18 in another embodiment,

FIG. 21 is a part of the section indicated by C-C in FIG. 18 in the embodiment of FIG. 19,

FIG. 22 is a part of the section indicated by C-C in FIG. 15 in the embodiment of FIG. 20,

FIG. 23 is the view from FIG. 18 in a further embodiment.

### DETAILED DESCRIPTION

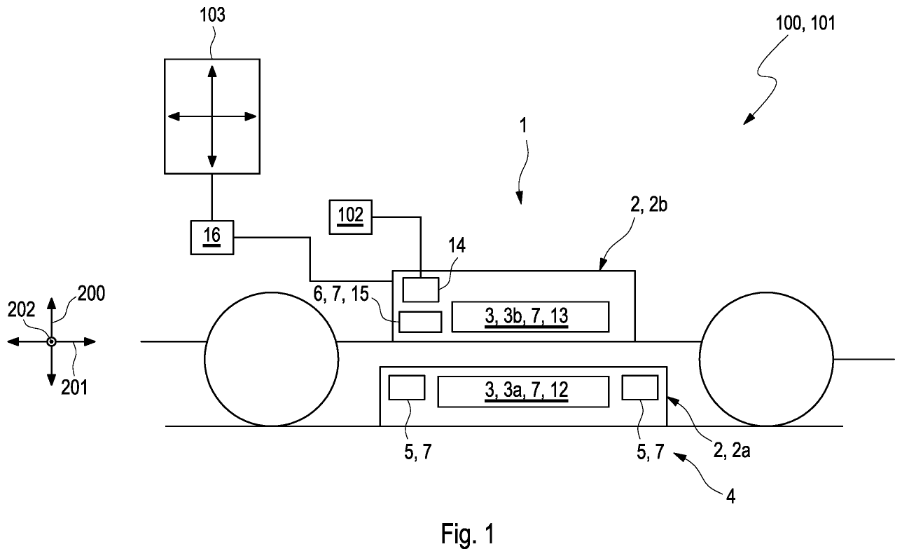

A system 1, as shown in FIG. 1 in a highly simplified and circuit-diagram-like manner, serves for inductive energy transfer to a mobile application 100, in particular to charge a battery 102 of the mobile application 100. In the embodiment shown, the application 100 is a motor vehicle 101. For this purpose, the system 1 has two induction charging devices 2 that interact inductively with one another during a charging operation, namely a stationary induction charging device 2, 2a and a mobile induction charging device 2, 2b for the application 100. In the embodiment shown, the stationary induction charging device 2, 2a is arranged purely by way of example on a roadway not designated in more detail. Of course, the stationary induction charging device 2, 2a can also be at least partially accommodated in the roadway and in particular be flush with the roadway. For inductive energy transfer during the charging operation, the relevant induction charging device 2 has an associated coil 3. These coils 3 are hereinafter also referred to as energy coils 3. The stationary induction charging device 2, 2a thus has a stationary energy coil 3, 3a and the mobile induction charging device 2, 2b has a mobile energy coil 3, 3b. During charging operation, one of the energy coils 3 thus serves as a primary coil 12 which generates an alternating magnetic field that induces a voltage for energy transfer in the other energy coil 3 serving as the secondary coil 13. In the embodiments shown, the energy coils 3 are each designed as a flat coil 7. During charging operation, the induction charging devices 2 are spaced apart from one another in a height direction 200. In order to make charging operation possible and to achieve high efficiencies during charging operation, the energy coils 3 are positioned relative to one another transversely to the height direction 200, i.e., in a longitudinal direction 201 running transversely to the height direction 200 and in a transverse direction 202 running transversely to the height direction 200 and transversely to the longitudinal direction 201. For this purpose, the system 1 has a positioning device 4, by means of which the position of the energy coils 3 relative to one another is identified in a positioning operation. Advantageously, the positioning operation takes place before the charging operation in order to achieve an optimal positioning of the energy coils 3 relative to one another and thus an increased efficiency.

In the embodiments shown, during charging operation, energy is transferred from the stationary induction charging device 2, 2a to the mobile induction charging device 2, 2b in order to charge a battery 102 of the motor vehicle 101. Accordingly, during charging operation, the stationary energy coil 3, 3a serves as the primary coil 12 and the mobile energy coil 3, 3b serves as the secondary coil 13. As can be seen from FIG. 1, the mobile induction charging device 2, 2a in the embodiment shown comprises a rectifier 14 connected between the secondary coil 13 and the battery 102 in order to convert the alternating voltage induced in the secondary coil 13 into a rectified voltage. Furthermore, in the embodiments shown, the height direction 200 corresponds to the Z direction of the motor vehicle 101. In addition, the longitudinal direction 201 and the transverse direction 202 correspond purely by way of example to the X direction and the Y direction of the motor vehicle 101.

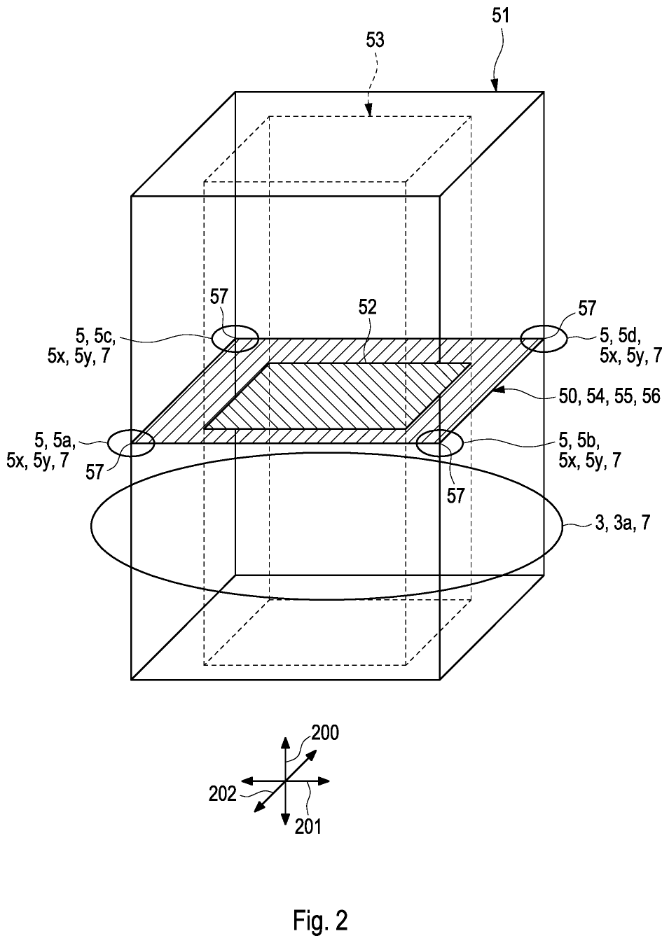

The positioning device 4 comprises four coils 5 for detecting the positioning of the energy coils 3 relative to one another, which each generate a field 60 in a positioning operation, which are explained hereinafter with reference to FIG. 2. These coils 5 are also referred to hereinafter as transmission coils 5. These fields 60 are also referred to hereinafter as positioning fields 60. In the embodiments shown, the positioning device 4 comprises exactly four transmission coils 5, namely a first transmission coil 5, 5a, a second transmission coil 5, 5b, a third transmission coil 5, 5c and a fourth transmission coil 5, 5d. Consequently, a total of four mutually distinguishable positioning fields 60 are generated, namely a first positioning field 60, 60a, a second positioning field 60, 60b, a third positioning field 60, 60c and a fourth positioning field 60, 60d (see FIGS. 7 and 8). In the embodiments shown, the particular transmission coil 5 generates a magnetic positioning field 60. In the view shown in FIG. 1, only two of the transmission coils 5 are visible. The positioning fields 60 are generated in such a way that they can be distinguished from one another. The positioning device 4 further comprises at least one receiver 6, which interacts with the positioning fields 60 during positioning operation. Due to the difference between the positioning fields 60, a distinction can be made between the positioning fields 60 by means of the at least one receiver 6. One of the induction charging devices 2 has the transmission coils 5 and the other induction charging device 2 has the receiver 6. In the embodiments shown, the stationary induction charging device 2, 2a has the transmission coils 5 and the mobile induction charging device 2, 2b has at least one receiver 6. In the embodiments shown, a single receiver 6 is provided purely by way of example. In the embodiments shown, the at least one receiver 6 is designed as a coil 15, which is also referred to hereinafter as a receiver coil 15. In the embodiments shown, the transmission coils 5 are different from the first energy coil 3, 3a. In the embodiments shown, the at least one receiver coil 15 is purely by way of example different from the second energy coil 3, 3b. As shown in FIG. 7, for example, the transmission coils 5 are spaced apart from one another and in each case two of the transmission coils 5 are arranged opposite one another.

In the embodiments shown, the transmission coils 5 are of identical design, i.e., they are identical parts. The particular transmission coil 5, as shown by way of example in FIG. 10, is a flat coil 7 which has at least one conductor track (not explicitly shown) which is wound around an associated winding axis (not shown) running parallel to the height direction 200. The relevant positioning field 60 thus has a main axis running along the height direction 200, i.e., it is at least predominantly positioned in or along the height direction 200 and can thus only be received locally transversely to the height direction 200.

In the embodiments shown, the positioning fields 60 are generated mutually distinguishably, for example, by the relevant positioning field 60 being generated with an associated frequency. This means that the particular transmission coil 5 is operated with an associated frequency so that the positioning fields 60 can be distinguished from one another. The frequencies lie in particular in the range between 120 kHz and 145 kHz and are spaced apart from one another by a few Hz to kHz, for example. For example, the frequencies can lie apart by 5 kHz or 1 kHz or 100 Hz or less. It is also possible to differentiate by means of duty cycles.

As can be seen from FIG. 2, the arrangement of the transmission coils 5 is such that the transmission coils 5 bound a virtual frame 50. The frame 50 is thus a virtual surface area bounded by the transmission coils 5. The virtual frame 50 defines the volume 51 extending from frame 50 in the height direction 200, which is also referred to hereinafter as frame volume 51. The energy coil 3 of the associated induction charging device 2, in the embodiments shown the stationary energy coil 3, 3a, is at least partially arranged within the virtual frame volume 51. The energy coil 3 of the associated induction charging device 2 is thus either at least partially within the frame 50 or offset in the height direction 200 to the frame 50 and consequently arranged within the frame volume 51. In the embodiments shown, the transmission coils 5 are spaced apart from the energy coil 3 of the associated induction charging device 2 in the height direction 200 and thus from the stationary energy coil 3, 3a. In the embodiments shown, in each case two of the transmission coils 5 are arranged opposite one another in the longitudinal direction 201 and in the transverse direction 202. The transmission coils 5 lying opposite one another in the longitudinal direction 201 are hereinafter also referred to as longitudinal transmission coils 5, 5x and the transmission coils 5 opposite one another in the transverse direction 202 are hereinafter also referred to as transverse transmission coils 5, 5y. Accordingly, the positioning fields 60 generated by the longitudinal transmission coils 5, 5x are hereinafter referred to relative to one another as longitudinal positioning fields 60, 60x and the positioning fields 60 generated by the transverse transmission coils 5, 5y are hereinafter referred to relative to one another as transverse positioning fields 60, 60y.

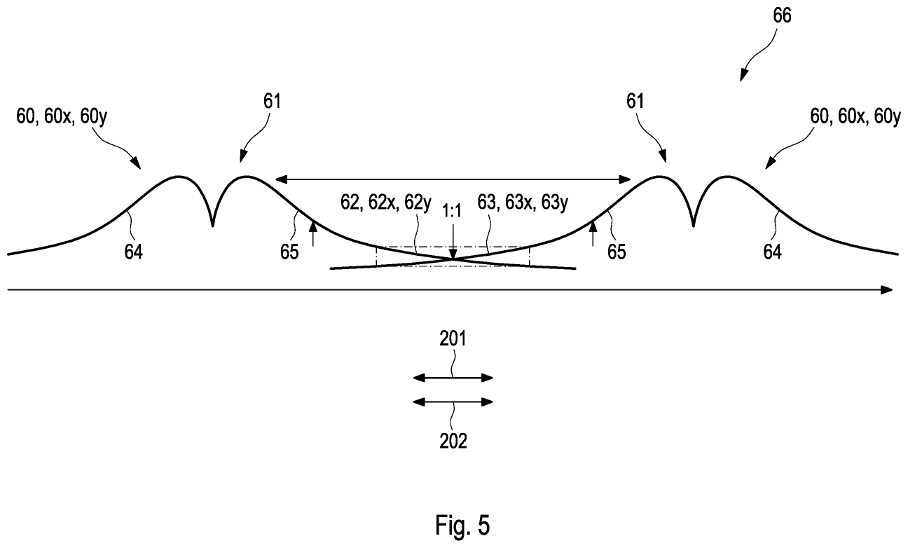

As shown in FIG. 2, for example, the transmission coils 5 in the embodiments shown are arranged in the corners 57 of a quadrilateral 54 shaped as a rectangle 55, so that the frame 50 has the shape of a rectangle 55. The frame volume 51 thus has the shape of a cuboid. In the embodiment in FIG. 2, the frame 50 has the shape of a square 56. Due to the arrangement of the transmission coils 5 in the corners 57 of the rectangle 55, the particular transmission coil 5 is not only a longitudinal transmission coil 5, 5x but also a transverse transmission coil 5, 5y. With the four transmission coils 5, there are thus in each case two pairs of transmission coils 5 lying opposite one another in the longitudinal direction 201 and in the transverse direction 202. Analogously, the relevant positioning field 60 is not only a longitudinal positioning field 60, 60x but also a transverse positioning field 60, 60y. In positioning operation, the ratio 62 (see FIG. 5) between at least two of the positioning fields 60 is identified by means of the at least one receiver 6. On the basis of the at least one ratio 62, it is further detected whether the energy coil 3 of the induction charging device 2 having the at least one receiver 6 is located within the virtual frame volume 51 and, depending on this, a positioning signal is output. In the embodiments shown, it is therefore detected on the basis of the at least one ratio 62 whether the mobile energy coil 3, 3b is located within the frame volume 51 and is thus arranged above the stationary energy coil 3, 3a in the height direction 200 and also at least partially overlaps with the stationary energy coil 3, 3a transversely to the height direction 200. The ratio 62 is correspondingly predetermined in advance.

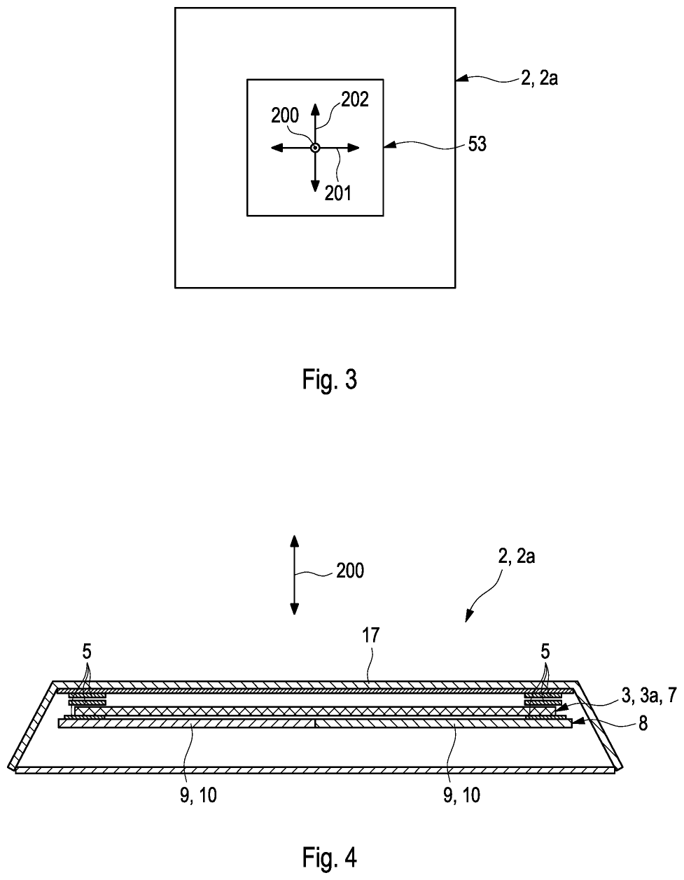

As can be seen from FIG. 2, in the embodiments shown, the positioning device 4 is designed such that a virtual target region 52 is defined within the frame 50. The target region 52 is thus smaller than the frame 50. The target region 52 within the frame volume 51 defines a virtual volume 53 extending in the height direction 200, which is also referred to hereinafter as target volume 53 and is shown by dashed lines in FIG. 2. The energy coil 3 of the induction charging device 2 having the transmission coils 5, i.e., the stationary energy coil 3, 3a in the embodiments shown, is arranged at least partially within the target volume 53. The positioning device 4 is further designed such that it detects, on the basis of the at least one identified ratio 62, whether the energy coil 3 of the induction charging device 2 having the receivers 6 is located within the target volume 53. Accordingly, at least a ratio 62 is predetermined in advance. The frame volume 51 and the target volume 53 are defined in such a way that with a corresponding arrangement of the energy coils 3 within the frame volume 51 and within the target volume 53, a high efficiency in charging operation, for example at least 90%, is achieved. The target volume 53 is selected such that the efficiency is greater in the case of an overlap within the target volume 53 that is greater than an overlap within the frame volume 51. As indicated in FIG. 3, the target volume 53 in the projection in the height direction 200 and thus the target region 52 is smaller than the associated induction charging device 2, in the embodiments shown therefore smaller than the stationary induction charging device 2, 2a.

As can also be seen from FIG. 5, in the embodiments shown, not a single ratio 62 but an associated ratio range 63 is defined in each case for the overlap of the energy coils 3 along the opposite-lying transmission coils 5. This means that an overlap of the energy coils 3 is detected when the identified ratio 62 lies within the associated ratio range 63. The ratio range 63 is here predetermined in advance. The relevant ratio range 63 is predetermined in advance by means of a fixed specification, so that the ratio range 63 is stored and calibration is not necessary.

The positioning signal can be used to move the application 100 manually or for autonomous movement of the application 100. In the embodiment of the motor vehicle 101, the positioning signal can therefore be used to signal to a driver (not shown) whether a desired alignment of the energy coils 3 to one another is present. For this purpose, the motor vehicle 101, as indicated in FIG. 1, can have an output device 103 which outputs corresponding signals.

The detection of the overlap of the energy coils 3 is explained with the aid of FIG. 5. FIG. 5 shows the course of two positioning fields 60, which are generated by means of two of the transmission coils 5 lying opposite one another in the longitudinal direction 201 or two lying opposite one another in the transverse direction 202. In FIG. 5, the positioning fields 60 shown are either longitudinal positioning fields 60, 60x or transverse positioning fields 60, 60y. One of the positioning fields 60 is shown by dashed lines for better differentiation. FIG. 5 shows the intensity curve 64 of the longitudinal positioning fields 60, 60x along the longitudinal direction 201 or of the transverse positioning fields 60, 60y along the transverse direction 202. According to FIG. 5, the positioning fields 60 of the opposite transmission coils 5 coincide within the target volume 53. As can be seen from FIG. 5, the positioning fields 60 have identical intensity curves 64. This means that the positioning fields 60 are each generated with the same field distribution. Furthermore, in the embodiments shown, the transmission coils 5 are designed and the positioning fields 60 are generated in such a way that an overall intensity curve 66 of the positioning fields 60 generated by the transmission coils 5 is symmetrical between the opposite-lying transmission coils 5 and thus intensity maxima 61 as well as symmetrical with respect to the stationary energy coil 3, 3b.

As can also be seen from FIG. 5, the relevant positioning field 60 has an intensity curve 64 with intensity flanks 65 leading to an intensity maximum 61. As can also be seen from FIG. 5, the intensity maxima 61 are spaced apart from one another. The transmission coils 5 are arranged correspondingly and/or the positioning fields 60 are generated. As can also be seen from FIG. 5, the intensity maximum 61 of the relevant positioning field 60 is shaped like a double hump. This is in particular due to the fact that when positioned correspondingly the receiver 6 detects a transition of the magnetic field lines (not shown). As indicated in FIG. 5, the relevant ratio range 62 is arranged between successive intensity flanks 65 of the positioning fields 60 generated by means of the opposite-lying, associated transmission coils 5 and is spaced apart from the intensity maxima 61. In this case, an associated longitudinal ratio range 63, 63x is predetermined in advance for each of the longitudinal positioning fields 60, 60x with opposite-lying intensity maxima 61 in the longitudinal direction 201, and an associated transverse ratio range 63, 63y is predetermined in advance for each of the transverse positioning fields 60, 60y with opposite-lying intensity maxima 61 in the transverse direction 202. The predetermined ratio ranges 63 are preferably stored so that a simple comparison between the identified ratio 62 and the associated ratio range 63 can be used to determine whether an associated overlap between the energy coils 3 is present.

This means that the longitudinal transmission coils 5, 5x are arranged and the longitudinal positioning fields 60, 60x are generated in such a way that the intensity maxima 61 of two longitudinal positioning fields 60, 60x are arranged opposite one another in the longitudinal direction 201. In this case, an associated longitudinal ratio range 63, 63x is predetermined in advance for at least two of the longitudinal positioning fields 60, 60x. From the longitudinal positioning fields 60, 60x received by means of the receiver 6, a longitudinal ratio 62, 62x between at least two of the longitudinal positioning fields 60, 60x is identified. An overlap of the energy coils 3 within the target volume 53 in the longitudinal direction 201 will be detected if the identified longitudinal ratio 62, 62x lies within the associated predetermined longitudinal ratio range 63, 63x. The same applies to the overlap in the transverse direction 202. This means that the transverse transmission coils 5, 5y are arranged and/or the transverse positioning fields 60, 60y are generated in such a way that the intensity maxima 61 of two transverse positioning fields 60, 60y are arranged opposite one another in the transverse direction 202. Furthermore, an associated transverse ratio range 63, 63y is predetermined in advance for at least two of the transverse positioning fields 60, 60y. In positioning operation, a transverse ratio 62, 62y between at least two of the transverse positioning fields 60, 60y is identified from transverse positioning fields 60, 60y received by the receiver 6. In this case, an overlap 3 of the energy coils 3 within the target volume 53 in the transverse direction 202 will be detected if the identified transverse ratio 62, 62y lies within the associated predetermined transverse ratio range 63, 63y. An overlap of the energy coils 3 in the longitudinal direction 201 and in the transverse direction 202 therefore occurs when at least one of the longitudinal ratios 62, 62y lies within the longitudinal ratio range 63, 63y and at least one of the transverse ratios 62, 62y lies within the transverse ratio range 63, 63y.

For example, for an overlap within the frame volume 51, a ratio range 63 between 10:0.05 and 0.05:10 can be given, and for an overlap within the target volume 53, a ratio range 63 between 1:0.1 and 0.1:1 can be given.

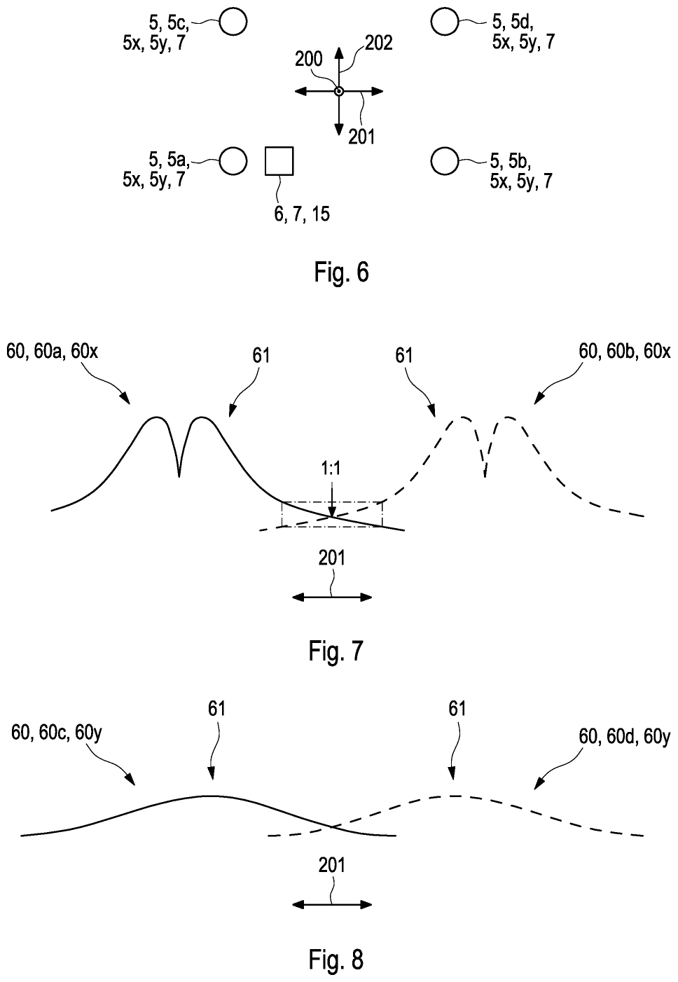

FIG. 6 shows a simplified plan view in the height direction 200 of the transmission coils 5. It is assumed that the receiver 15 moves between in the longitudinal direction 201 along the first transmission coil 5, 5a and the second transmission coil 5, 5b. FIG. 7 shows the positioning fields 60 of the first transmission coil 5, 5a and of the second transmission coil 5, 5b received by the receiver 15 during this movement along the longitudinal direction 201 and thus the first positioning field 60, 60a and the second positioning field 60, 60b. FIG. 8 shows the positioning fields 60 of the third transmission coil 5, 5c and of the fourth transmission coil 5, 5b received during this movement of the receiver 15 along the longitudinal direction 201 and thus the fourth positioning field 60, 60c and the fourth positioning field 60, 60d. Relative to one another the first positioning field 60, 60a and the second positioning field 60, 60b are longitudinal positioning fields 60, 60x. Analogously, the third positioning field 60, 60c and the fourth positioning field 60, 60d are relative to one another longitudinal positioning fields 60, 60x. As a comparison of FIGS. 7 and 8 shows, the double-hump shape of the positioning fields 60 received by the receiver 15 is more pronounced for the positioning fields 60 close to the receiver 15 than for the positioning fields 60 further away from the receiver 15. In the example described, the double-hump shape is therefore more pronounced for the received first positioning field 60, 60a and second positioning field 60, 60b than for the received third positioning field 60, 60c and fourth positioning field 60, 60d. In FIG. 8, the double-hump shape of the more distant positioning fields 60, i.e., the example of the third positioning field 60, 60c and the fourth positioning field 60, 60d, is not shown for better understanding. Accordingly, the ratio 62 of the two positioning fields 60 with the opposite-lying intensity maxima 61 is advantageously identified and, if the ratios 62 deviate above a predetermined limit value, the ratio 62 of the positioning fields 60 with the lower intensity will be used to detect the relative position. As a result, those positioning fields 60 are used, the identified ratio 62 of which is further spaced apart at the intensity maxima 61. This prevents in particular the double-hump shape of the intensity maxima 61 described above from leading to a false detection of the position. If, on the other hand, the two ratios 62 substantially correspond to one another, i.e., if the ratios 62 are substantially the same or fall within a predetermined range of values, the two ratios 62 will be averaged to determine the relative position.

If the identified ratio 62 deviates from the associated ratio range 63 towards an intensity maximum 61 of one of the associated positioning fields 60, an offset of the energy coil 3 of the receiving induction charging device 2, which thus has the receiver 6, towards that intensity maximum 61 and thus towards the transmission coil 5 generating the intensity maximum 61, towards which the ratio 62 is shifted, will also be detected. In other words, if the identified longitudinal ratio 62, 62x is shifted from the associated longitudinal ratio range 63, 63x to one of the intensity maxima 61 of one of the associated longitudinal positioning fields 60, 60x, this means that there is an offset of the mobile energy coil 3, 3b from the target volume 53 along the longitudinal direction 201 to that longitudinal transmission coil 5, 5x which generates the longitudinal positioning field 60, 60x with that intensity maximum 61 to which the identified longitudinal ratio 62, 62x is shifted. The same applies to the identified transverse ratio 62, 62y. In other words, if the identified transverse ratio 62, 62y is shifted from the associated transverse ratio range 63, 63y to one of the intensity maxima 61 of one of the associated transverse positioning fields 60, 60y, this means that there is an offset of the mobile energy coil 3, 3b from the target volume 53 along the transverse direction 202 to that transverse transmission coil 5, 5y which generates the transverse positioning field 60, 60y with that intensity maximum 61 to which the identified transverse ratio 62, 62y is shifted. A navigation of the mobile induction charging device 2, 2a can thus be realized in such a way that an overlap of the two energy coils 3 in the target volume and thus not only in the longitudinal direction 201 but also in the transverse direction 202 is achieved. This can, as indicated in FIG. 1, be effected by means of the output device 103 in order to output whether and in which direction a relative movement of the mobile induction charging device 2, 2b relative to the stationary induction charging device 2, 2a is necessary in order to achieve an overlap of the energy coils 3 in the longitudinal direction 201 and in the transverse direction 202. In the embodiment shown in FIG. 1, this is effected purely visually by means of the display of arrows indicated in FIG. 1. It is also conceivable for the output device 103 to output an acoustic signal. It is also conceivable to implement the result autonomously, so that the motor vehicle 101 is driven autonomously in order to achieve an overlap of the energy coils 3.

A maximized efficiency in charging operation is achieved with a corresponding position of the energy coils 3 relative to one another, which is also referred to hereinafter as a centered arrangement. The centered arrangement is in each case assigned a ratio 63 within the ratio ranges 63. This means that with a predetermined centering longitudinal ratio in the longitudinal ratio range 63, 63x, there is a mutually centered arrangement of the energy coils 3 in the longitudinal direction 201. In addition, with a predetermined centering transverse ratio in the transverse ratio range 63, 63y, there is a mutually centered arrangement of the energy coils 3 in the transverse direction 202. An overall centered arrangement is thus present if at least one of the identified longitudinal ratios 62, 62x corresponds to the associated centering longitudinal ratio and at least one of the identified transverse ratios 62, 62y corresponds to the associated centering transverse ratios. The relevant centering ratio in the embodiments shown is 1:1, as indicated in FIG. 5. Analogous to the above explanation, it is possible to implement navigation in such a way that an overall centered arrangement of the energy coils 3 is present.

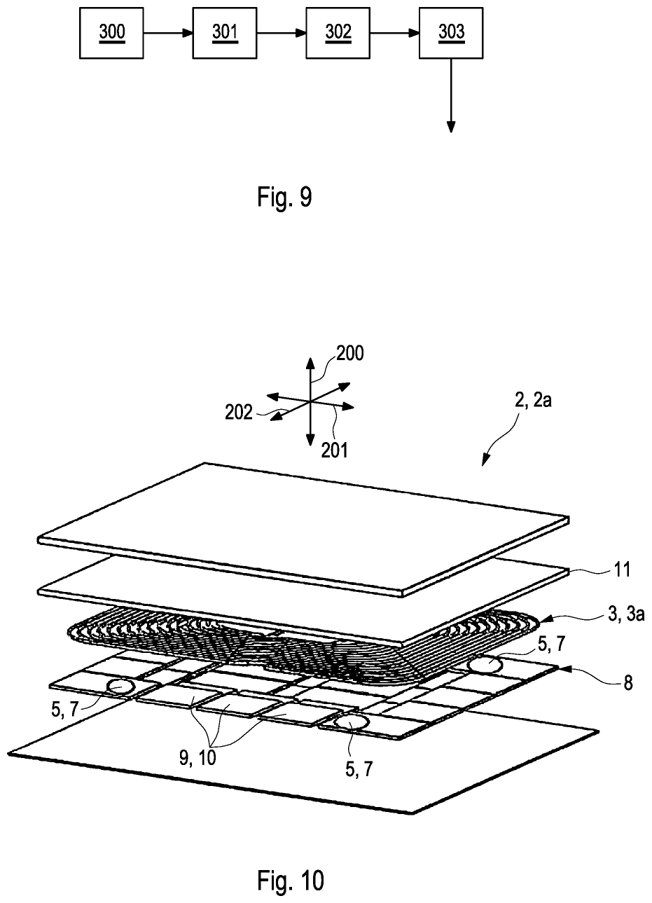

FIG. 9 shows a flow chart to explain the detection of the position of the energy coils 3 relative to one another. The positioning operation is initiated when the application 100 and thus the mobile induction charging device 2, 2b approaches the stationary induction charging device 2, 2a. This is the case, for example, when a distance between the induction charging devices 2 transversely to the height direction 200 is less than 1.5 m, in particular less than 1 m, preferably less than 0.5 m. The positioning operation can be initiated, for example, by means of a ping signal emitted by the mobile induction charging device 2, 2b, upon receipt of which the mobile induction charging device 2, 2a generates the positioning fields 60 with the transmission coils 5. According to FIG. 9, in a method step 300, which is also referred to hereinafter as reception step 300, the positioning fields 60 are received by the receiver 6 and separated from one another in a subsequent method step 301 such that the intensity of the positioning fields 60 can be distinguished from one another. In the method step 301, in particular a Fourier transform of the signals received by means of the receiver 6 is carried out, in the case of a receiver coil 15—in other words of the voltages induced in the receiver coil 6 with the positioning fields 60. The method step 301 is also referred to hereinafter as separation step 301. The result of the separation step 301 is therefore an associated value for the relevant positioning field 60, so that a total of four values are present. From these values, in a method step 302, the associated longitudinal ratios 62, 62x and transverse ratios 62, 62y are identified for the longitudinal positioning fields 60, 60x and for the transverse positioning fields 60, 60y. It is advantageous to average several values, for example the last ten values identified, in order to increase the accuracy of the method and/or reduce the susceptibility to errors. The method step 302 is also referred to hereinafter as ratio step 302. The ratios 62 identified in the ratio step 102 are in a method step 303 compared with the corresponding previously predetermined ratio ranges 63 and, with the aid of the comparison, it is identified whether there is a corresponding overlap of the energy coils 3, i.e., the arrangement of the mobile energy coil 3, 3b within the target volume 53. The method step 303 is also referred to hereinafter as comparison step 303. The comparison step 303 outputs at least one positioning signal, as indicated in FIG. 9. The positioning signal is preferably used, as explained above, for the navigation of the mobile application 100. Accordingly, the positioning signals can be made available to the output device 103.

To carry out the detection of the relative position, a correspondingly designed control device 16, shown in simplified form in FIG. 1, can be used. The control device 16 can be a constituent part of the positioning device 4, of the system 1 or of the application 100. The method can be carried out by means of a computer program product.

According to FIG. 4, the induction charging device 2 having the transmission coils 5, in the present case, i.e., the stationary induction charging device 2, 2a, has in the embodiments shown a flat coil 7 as the energy coil 3, which flat coil is larger than the transmission coils 5. In addition, the stationary induction charging device 2, 2a has a magnetic flux guide unit 8 for guiding the alternating field generated by the stationary energy coil 3, 3a during charging operation. For this purpose, the magnetic flux guide unit 8 in the embodiments shown has magnetic flux guide elements 9 which are designed as ferrite plates 10. The transmission coils 5 overlap the stationary energy coil 3, 3a and are arranged in corners 57 of a rectangle 55 (see, for example, FIG. 2) and in a plane running parallel to the stationary energy coil 3, 3a. Furthermore, the transmission coils 5 are arranged above the magnetic flux guide unit 9.

FIG. 4 shows possible relative positions of the transmission coils 5 in relation to the stationary energy coil 3, 3a. Accordingly, the transmission coils 5 can be arranged in the height direction 200 between the stationary energy coil 3, 3a and the magnetic flux guide unit 8, on the side of the magnetic flux guide unit 8 facing away from the stationary energy coil 3, 3a or on the side of a foreign object detection device 17 of the stationary induction charging device 2, 2a facing the stationary energy coil 3, 3a.

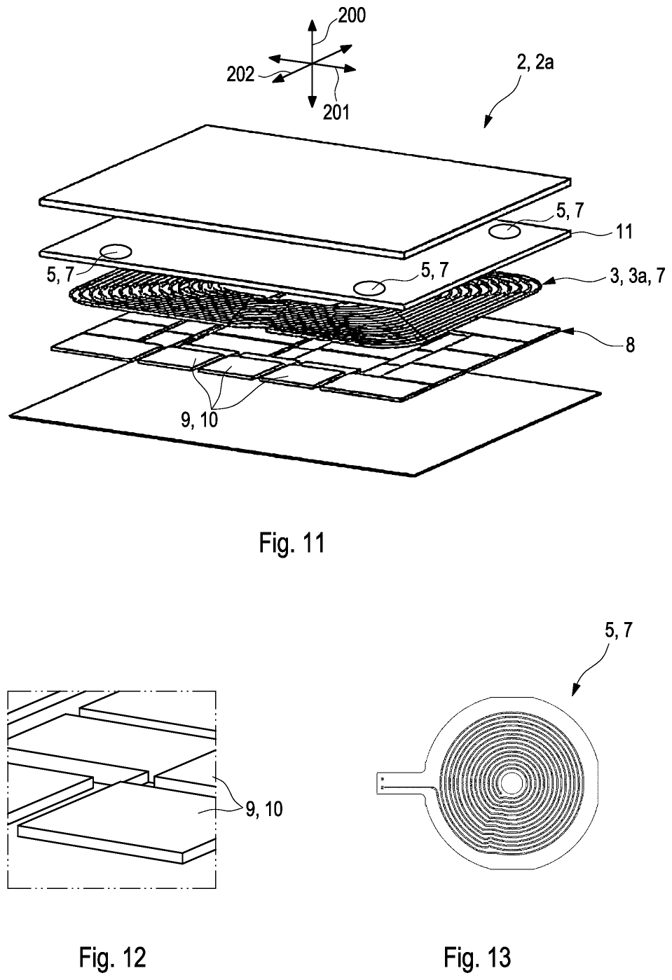

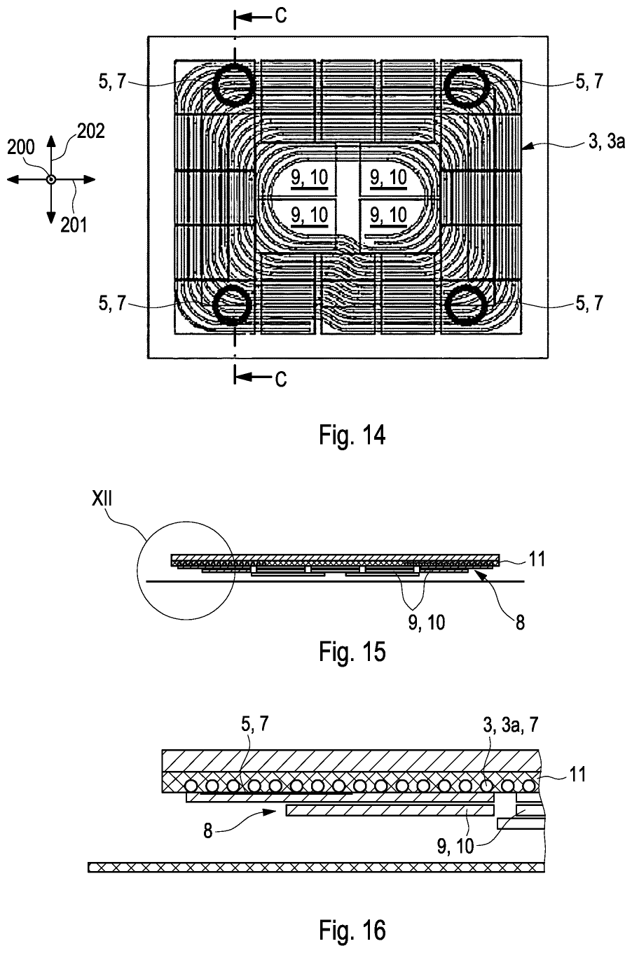

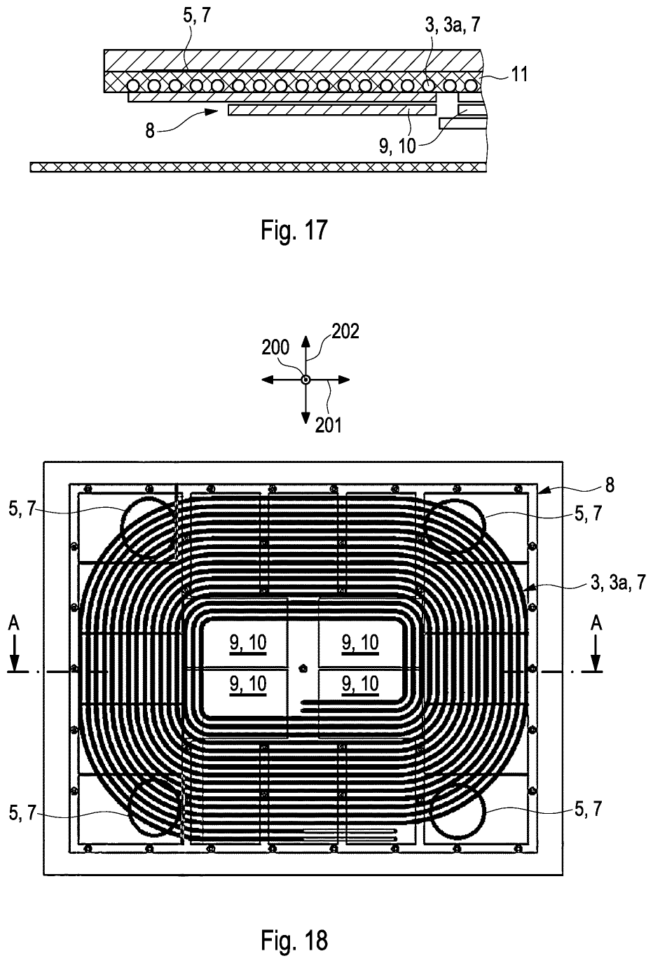

The embodiments in FIGS. 10 to 12 and 14 to 17 show a stationary induction charging device 2 with pyramid-like magnetic flux guide elements 9 (see FIG. 12), which is designed in particular according to the current SAE/ISO. FIG. 14 shows a plan view of the stationary energy coil 3, 3a, in which the position of the transmission coils 5 can be seen. Accordingly, as explained above, the transmission coils 5 can be arranged between the energy coil 3 and the magnetic flux guide unit 8, as shown in FIGS. 10 and 16. Alternatively, the transmission coils 5 can be arranged on the side of the stationary energy coil 3, 3a facing away from the magnetic flux guide unit 8, as shown in FIGS. 11 and 17. In the embodiment in FIG. 17, the transmission coils 5 are arranged on the side facing away from the magnetic flux guide unit 8 of a coil carrier 11 carrying the mobile energy coil 3, 3a. The thickness of the particular transmission coil 5 running in the height direction 200 is preferably a maximum of 1 cm.

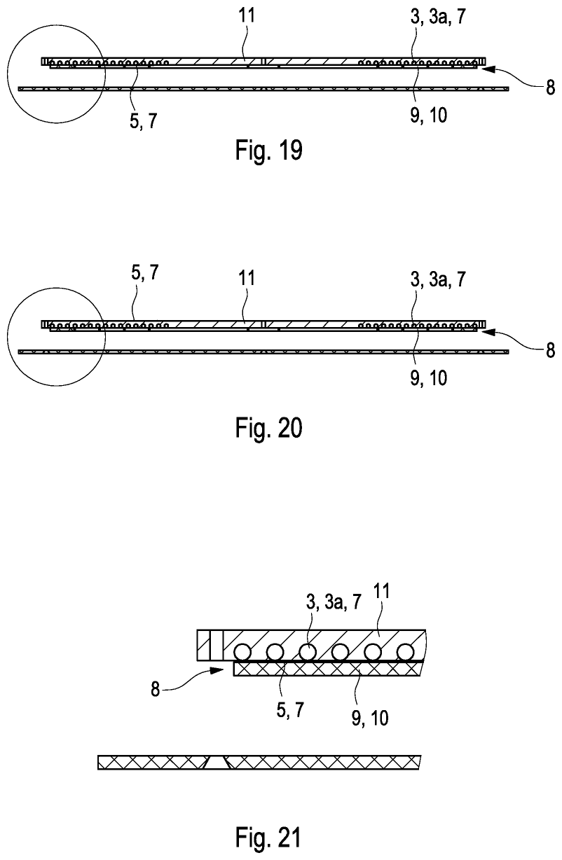

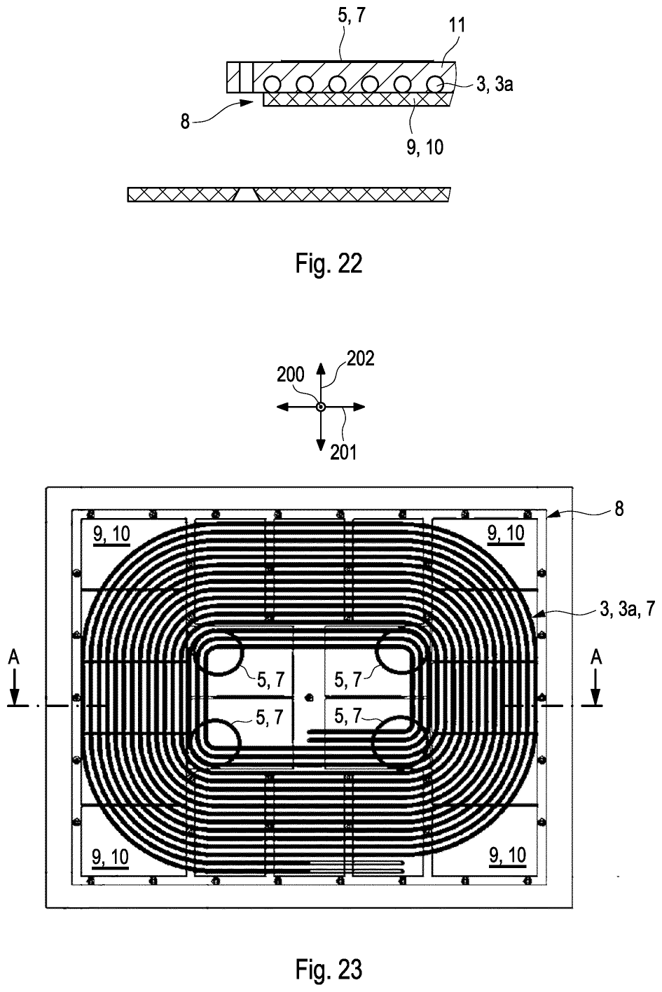

FIG. 18 to 22 show further embodiments of the stationary induction charging device 2, 2a, for example according to SAE 2016. FIG. 18 shows a plan view of the stationary energy coil 3, 3a, in which the position of the transmission coils 5 is shown. In the embodiments shown in FIGS. 19 and 21, the transmission coils 5 are arranged between the energy coil 3, 3a and the magnetic flux guide unit 8. In the embodiment shown in FIGS. 20 and 22, the transmission coils 5 are arranged on the side facing away from the magnetic flux guide unit 8 of a coil carrier 11 carrying the mobile energy coil 3, 3a. The thickness of the particular transmission coil 5 running in the height direction 200 is preferably a maximum of 1 cm.

FIG. 23 shows a further embodiment which differs from the preceding embodiments in that the transmission coils 5 are arranged offset inwardly.

1. A system for inductive energy transfer, comprising:
a stationary induction charging device including a stationary energy coil;
a mobile induction charging device including a mobile energy coil; and
a positioning device configured to detect a positioning of the stationary energy coil and the mobile energy coil relative to one another;
wherein, during a charging operation of the system, one of stationary energy coil and the mobile energy coil provides an alternating magnetic field which induces a voltage for energy transfer in the other of the stationary energy coil and the mobile energy coil;
wherein, during the charging operation, the stationary induction charging device and the mobile induction charging device are disposed spaced apart from one another in a height direction;
wherein the positioning device includes i) four transmission coils in one of the stationary induction charging device and the mobile induction charging device and ii) at least one receiver in the other of the stationary induction charging device and the mobile induction charging device;
wherein the four transmission coils are arranged spaced apart from one another and, in each case, two transmission coils of the four transmission coils are arranged opposite one another such that the four transmission coils bound a virtual frame defining a virtual frame volume that extends in the height direction, the energy coil of the associated induction charging device arranged at least partially within the virtual frame volume;
wherein the positioning device is configured such that the four transmission coils, during a positioning operation, provide a plurality of positioning fields that are distinguishable from one another;
wherein the at least one receiver is configured such that, during the positioning operation, the at least one receiver interacts with the plurality of positioning fields; and
wherein the positioning device is further configured such that, during the positioning operation, the positioning device identifies a ratio between at least two of the plurality of positioning fields via the at least one receiver, detects on a basis of the ratio whether the energy coil of the induction charging device having the at least one receiver is located within the virtual frame volume, and, depending thereon, outputs a positioning signal.

2. The system according to claim 1, wherein:
the positioning device is further configured such that a virtual target region is bounded within the virtual frame, the virtual target region defining a virtual target volume within the virtual frame volume which extends in the height direction and within which the energy coil of the induction charging device having the four transmission coils is at least partially arranged, and
the positioning device is further configured such that the positioning device detects on a basis of the ratio whether the energy coil of the induction charging device having the at least one receiver is located within the virtual target volume.

3. The system according to claim 1, wherein the positioning device is further configured such that at least one of the four transmission coils provides a magnetic positioning field during the positioning operation.

4. The system according to claim 1, wherein:
during the positioning operation, each transmission coil of the four transmission coils provides a positioning field of the plurality of positioning fields, the positioning field having an intensity maximum; and
at least one of i) the four transmission coils are arranged spaced apart from one another and ii) the positioning device is configured to operate such that the intensity maxima of the positioning fields are disposed spaced apart from one another and the positioning fields of at least two of the opposite-lying transmission coils coincide in the virtual frame volume.

5. The system according to claim 4, wherein the positioning device is further configured such that the virtual frame volume is arranged in a predetermined ratio range between the intensity maxima of the positioning fields of the at least two opposite-lying transmission coils.

6. The system according to claim 5, wherein the predetermined ratio range is spaced apart from the intensity maxima.

7. The system according to claim 4, wherein:
each positioning field of the plurality of positioning fields has an intensity curve with an intensity flank leading to the intensity maximum; and
the virtual frame volume is arranged between successive intensity flanks of the positioning fields provided via the opposite-lying transmission coils.

8. The system according to claim 4, wherein at least one of i) the four transmission coils are arranged spaced apart from one another and ii) the positioning device is configured to operate such that intensities of at least two of the plurality of positioning fields provided via the opposite-lying transmission coils correspond to one another centrally in relation to the energy coil of the induction charging device having the four transmission coils.

9. The system according to claim 1, wherein the four transmission coils are identical.

10. The system according to claim 1, wherein at least one of i) the four transmission coils are configured and ii) the positioning device is configured to operate such that the four transmission coils each provide the same intensity curves during the positioning operation.

11. The system according to claim 1, wherein at least one of i) the four transmission coils are configured and ii) the positioning device is configured to operate such that, during the positioning operation, an overall intensity curve of the plurality of positioning fields provided via the four transmission coils is symmetrical.

12. The system according to claim 1, wherein the four transmission coils includes:
two longitudinal transmission coils arranged opposite one another in a longitudinal direction extending transversely to the height direction; and
two transverse transmission coils arranged opposite one another in a transverse direction extending transversely to the height direction and transversely to the longitudinal direction.

13. The system according to claim 1, wherein the positioning device is further configured such that, during the positioning operation, the four transmission coils operate at different frequencies such that the plurality of positioning fields are distinguishable.

14. The system according to claim 1, wherein the positioning device is further configured such that, during the positioning operation, the four transmission coils each operate with an associated duty cycle such that the plurality of positioning fields are distinguishable.

15. The system according to claim 1, wherein at least one of the four transmission coils is a flat coil.

16. The system according to claim 1, wherein the four transmission coils are arranged such that the virtual frame is a quadrilateral.

17. The system according to claim 16, wherein the four transmission coils are arranged such that the virtual frame is a square.

18. The system according to claim 16, wherein the four transmission coils are arranged at a plurality of corners of the quadrilateral.

19. The system according to claim 1, wherein the four transmission coils are different from the energy coil of the associated induction charging device.

20. The system according to claim 1, wherein the at least one receiver of the positioning device includes a single receiver.

21. The system according to claim 1, wherein the stationary induction charging device includes the four transmission coils and the mobile induction charging device includes the at least one receiver.

22. The system according to claim 1, wherein the mobile induction charging device includes the four transmission coils and the stationary induction charging device includes the at least one receiver.

23. The system according to claim 1, wherein:
the induction charging device having the four transmission coils further includes a magnetic flux guide unit with a plurality of magnetic flux guide elements for guiding the alternating magnetic field provided during the charging operation; and
at least one of the four transmission coils is arranged on a side of the magnetic flux guide unit facing the energy coil of the other induction charging device.

24. The system according to claim 1, wherein:
the four transmission coils are each structured as a flat coil,
the induction charging device having the four transmission coils further includes:
a flat coil as the energy coil, which is larger than the four transmission coils; and
a magnetic flux guide unit including a plurality of magnetic flux guide elements for guiding the alternating magnetic field provided via the stationary energy coil during the charging operation; and
the four transmission coils overlap the energy coil and are arranged in a plurality of corners of a quadrilateral in a plane extending parallel to the energy coil.

25. The system according to claim 24, wherein the four transmission coils are arranged at least one of:
between the energy coil and the magnetic flux guide unit; and
on a side facing away from the energy coil of a coil carrier carrying the energy coil.

26. The system according to claim 1, wherein the positioning device is further configured such that a main axis of a respective positioning field of the plurality of positioning field extends along the height direction.

27. The system according to claim 26, wherein a particular transmission coil of the four transmission coils is wound around a winding axis extending at least substantially in the height direction such that the main axis of the respective positioning field extends along the height direction.

28. An induction charging device of the system according to claim 1.

29. A mobile application, comprising a mobile induction charging device of the system according to claim 1.
